(19) United States
(12) Patent Application Publication
(10) Pub. No.: US 2009/0108511 A1
(43) Pub. Date: Apr. 30, 2009

(54) Variable force spring

(76) Inventors: Donald B. Bivin, Oakland, CA (US); Marshall S. Kriesel, Saint Paul, MN (US); Joshua W. Kriesel, San Francisco, CA (US); Alan D. Langerud, Plymouth, MN (US)

Correspondence Address: JAMES E. BRUNTON, ESQ., P. O. BOX 29000, GLENDALE, CA, 91209, US

(21) Appl. No.: 11/982,478

(22) Filed: Oct. 31, 2007

(51) Int. Cl. F16F 1/06

(52) U.S. Cl. 267/167

(57) ABSTRACT

A variable force spring that includes an elongated, pre-stressed strip of retractable spring material that is formed into coils and having a variation in cross-sectional mass along the length. In one instance, the variation in cross-sectional mass along the length of the retractable spring is achieved by varying the width of the pre-stressed spring along its length.

### FIELD OF THE INVENTION

The present invention relates generally to mechanical springs. More particularly, the invention concerns a variable force spring of unique construction in its preferred form, the variable force spring of the invention comprises an elongated, pre-stressed strip of spring material that is formed into coils and exhibits a cross-sectional mass that varies along its length.

### DISCUSSION OF THE PRIOR ART

Springs are fundamental mechanical components which form the basis of many mechanical systems. A spring can be defined to be an elastic member that exerts a resisting force when its shape is changed. Most springs are assumed linear and obey the Hooke's Law. Common types of springs include compression springs, extension springs and torsion springs.

A widely used variation of the extension spring is the so-called “constant force spring”. The typical constant force spring comprises a tightly coiled wound band of pre-hardened spring steel or stainless steel strip with built-in curvature so that each turn of the strip wraps tightly on its inner neighbor. When the strip is extended (deflected) the inherent stress resists the loading force as does a common extension spring, but with a force that is nearly independent of the degree of extension. The constant-force springs, which are available in a wide variety of sizes, are well suited to long extensions with no load build-up. In use, the spring is usually mounted with the internal diameter (ID) tightly wrapped on a drum and the free end attached to the loading force. Considerable flexibility is possible with constant-force springs because the load capacity can be multiplied by using two or more strips in tandem, or back-to-back.

A commonly used constant force spring, called a “Negator spring” is readily commercially available from a number of sources including Stock Drive Products/Sterling Instruments of new Hyde Park, N.Y. The prior art Negator extension spring comprises a pre-stressed flat strip of spring material that is formed into virtually constant radius coils around itself or on a drum having a fixed radius. The force delivered by the constant force Negator spring is generated when the radius of curvature of the spring changes. This change in radius of curvature of the spring takes place in what may be designated as the active region of the spring, which is located proximate the area where the spring coils around itself. This active region of the spring comprises only a small percentage of the total length of the spring and the generation of force takes place locally in the spring and this local or active region changes as the spring is coiled or uncoiled. It is this change in radius of curvature of the spring that is responsible for the generation of the force.

The force delivered by a typical prior art constant force spring, such as the Negator extension spring depends on several structural and geometric factors. Structural factors include material composition and heat treatment. Geometric factors include the thickness of the spring, the change in radius of curvature of the spring as the spring is extended, and the width of the spring.

### SUMMARY OF THE INVENTION

By way of brief summary, one form of the variable force spring of the invention comprises an elongated, pre-stressed strip of spring material that is formed into coils and exhibits a cross-sectional mass that varies along its length.

With the forgoing in mind, it is an object of the invention is to provide a variable force spring that comprises an elongated, pre-stressed strip of retractable spring material that is formed into coils and one in which variation in cross-sectional mass along the length of the retractable spring is achieved by varying the width of the pre-stressed spring along its length.

Another object of the invention is to provide a variable force spring of the character described in which variation in cross-sectional mass along the length of the retractable spring is achieved by providing spaced-apart apertures in the pre-stressed spring along its length.

Another object of the present invention to provide a variable force spring of the character described in the preceding paragraphs, which is ideally suited for use in connection with compact fluid delivery devices used in controllably dispensing fluid medicaments to ambulatory patients from pre-filled or field-filled containers at a uniform rate.

Another object of the invention is to provide a variable force spring of the character described in the preceding paragraphs that is easy and inexpensive to manufacture in large quantities.

### BRIEF DESCRIPTION OF THE DRAWINGS

FIG. 1 is a generally perspective view of a prior art retractable spring.

FIG. 2 is a generally perspective view of the prior art retractable spring shown in FIG. 1 as it appears in a partially expanded configuration.

FIG. 2A is a generally illustrative of one form of fluid container having a collapsible reservoir with which the variable force springs of the present invention can be used to controllably collapse the reservoir of the fluid container.

FIG. 2B is a generally illustrative view, similar to FIG. 2A, but showing the container in a collapsed configuration.

FIG. 3 is a generally illustrative view of the configuration of a retractable spring that would deliver a force that decreases by a factor of w₂/w₁ as the bottle, or container more compresses and the spring returns from its fully extended configuration to its fully coiled configuration.

FIG. 4 is a generally graphical representation plotting pressure versus the length of the reservoir container (depicted as x) when a constant force spring is used to compress a bellows-like reservoir container.

FIG. 5 is a generally graphical representation, similar to FIG. 4, plotting pressure versus the degree of compression for the reservoir container when the container is compressed by a constant force spring.

FIG. 6 is a generally illustrative view of the retractable spring of a first modified configuration.

FIG. 6A is a generally graphical representation plotting force exerted by the spring shown in FIG. 6 versus position along the length of the spring.

FIG. 7 is a generally illustrative view of the retractable spring of a second modified configuration.

FIG. 7A is a generally graphical representation plotting force exerted by the spring shown in FIG. 7 versus position along the length of the spring.

FIG. 8 is a generally illustrative view of the retractable spring of a third modified configuration.

FIG. 8A is a generally graphical representation plotting force exerted by the spring shown in FIG. 8 versus position along the length of the spring.

FIG. 9 is a generally illustrative view of the retractable spring of a fourth modified configuration.

FIG. 9A is a generally graphical representation plotting force exerted by the spring shown in FIG. 9 versus position along the length of the spring.

FIG. 10 is a generally illustrative view of the retractable spring of a fifth modified configuration.

FIG. 10A is a generally graphical representation plotting force exerted by the spring shown in FIG. 10 versus position along the length of the spring.

FIG. 11 is a generally illustrative view of the retractable spring of a sixth modified configuration.

FIG. 11A is a generally graphical representation plotting force exerted by the spring shown in FIG. 11 versus position along the length of the spring.

FIG. 12 is a generally illustrative view of the retractable spring of a seventh modified configuration.

FIG. 12A is a generally graphical representation plotting force exerted by the spring shown in FIG. 12 versus position along the length of the spring.

FIG. 13 is a generally illustrative view of the retractable spring of an eighth modified configuration.

FIG. 13A is a generally graphical representation plotting force exerted by the spring shown in FIG. 13 versus position along the length of the spring.

FIG. 14 is a generally illustrative view of the retractable spring of a ninth modified configuration.

FIG. 14A is a generally graphical representation plotting force exerted by the spring shown in FIG. 14 versus position along the length of the spring.

FIG. 15 is a generally illustrative view of the retractable spring of a tenth modified configuration.

FIG. 15A is a generally graphical representation plotting force exerted by the spring shown in FIG. 15 versus position along the length of the spring.

FIG. 16 is a generally illustrative view of the retractable spring of an eleventh modified configuration.

FIG. 16A is a generally graphical representation plotting force exerted by the spring shown in FIG. 16 versus position along the length of the spring.

FIG. 17 is a generally illustrative view of the retractable spring of a twelfth modified configuration.

FIG. 17A is a generally graphical representation plotting force exerted by the spring shown in FIG. 17 versus position along the length of the spring.

FIG. 18 is a generally illustrative view of the retractable spring of a thirteenth modified configuration.

FIG. 18A is a generally graphical representation plotting force exerted by the spring shown in FIG. 18 versus position along the length of the spring.

FIG. 19 is a generally perspective view of the retractable spring the retractable spring of a fourteenth modified configuration.

FIG. 19A is a generally graphical representation plotting force exerted by the spring shown in FIG. 19.

FIG. 20 is a generally illustrative view of the retractable spring of a fifteenth modified configuration.

FIG. 20A is a generally graphical representation plotting force exerted by the spring shown in FIG. 20 versus position along the length of the spring.

FIG. 21 is a generally illustrative view of the retractable spring of a sixteenth modified configuration.

FIG. 21A is a generally graphical representation plotting force exerted by the spring shown in FIG. 21 versus position along the length of the spring.

FIG. 22 is a generally illustrative view of the retractable spring of a seventeenth modified configuration.

FIG. 22A is a generally graphical representation plotting force exerted by the spring shown in FIG. 22 versus position along the length of the spring.

FIG. 23 is a generally illustrative view of the retractable spring of an eighteenth modified configuration.

FIG. 23A is a generally graphical representation plotting force exerted by the spring shown in FIG. 23 versus position along the length of the spring.

FIG. 24 is a generally perspective, illustrative view of still another form of the variable spring which is here shown as a laminate construction.

### DESCRIPTION OF THE INVENTION

Definitions: As used herein, the following terms have the following meanings:

### Constant Force Spring

Constant force springs are a special variety of extension spring. They are tightly coiled wound bands of pre-hardened spring steel or stainless steel strip with built-in curvature so that each turn of the strip wraps tightly on its inner neighbor. When the strip is extended (deflected) the inherent stress resists the loading force; the same as a common extension spring, but at a nearly constant (zero) rate. The constant-force spring is well suited to long extensions with no load build-up. In use, the spring is usually mounted with the internal diameter (ID) tightly wrapped on a drum and the free end attached to the loading force. Considerable flexibility is possible with constant-force springs because the load capacity can be multiplied by using two or more strips in tandem, or back-to-back. Constant force springs are available in a wide variety of sizes.

### Force Generating Region

The force generating region of the prior art constant force spring means the region of the spring in which the force is generated. More particularly, it should be understood that it is the change in radius of curvature of the prior art constant force spring that is responsible for the generation of the force produced by the spring. In fact, the radius of curvature of the prior art constant for spring changes from essentially infinity to a value equal to the radius of the spool on which the spring is wound.

Note that because the force generating region takes up some portion of the length of the spring it will tend to average any point-by-point changes in physical or structural properties of the spring.

It should also be kept in mind that this force generating region takes up some part of the total length of the spring, and that this force generating region moves as the degree of extension of the spring changes.

### Modified Constant Force Spring (Variable Force Spring)

The modified constant force spring or variable force spring of the present invention comprises a spring of highly novel configuration that includes an elongated, pre-stressed strip of spring material that may be metal, a polymer, a plastic, or a composite material with built-in curvature so that, like the conventional constant force spring, each turn of the strip wraps tightly on its inner neighbor. Uniquely, the elongated pre-stressed strip of spring material exhibits a cross-sectional mass that varies along said length. This variation in cross-sectional mass along the length of the spring can be achieved in various ways, as for example, by varying the width of the pre-stressed strip along its length and by providing spaced-apart apertures in the pre-stressed strip along its length.

### Mass of Material

The term “mass of material” when used herein in connection with the modified constant force spring of the invention means the mass of material in the “force generating region” as previously defined herein. More particularly, increasing the mass of material in the “force generating region” will increase the force provided by the spring. Conversely, decreasing the mass of material in the “force generating region” will result in a reduction of the force generated by the spring. The mass in the active region can be changed by changing the thickness of the spring, the width of the spring, the density of material of the spring, or any combination of these.

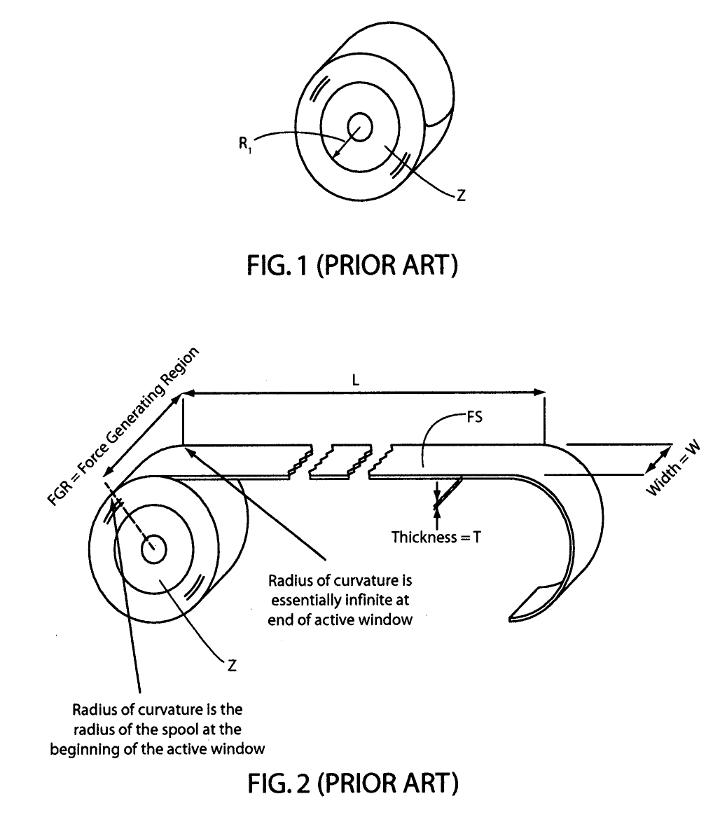

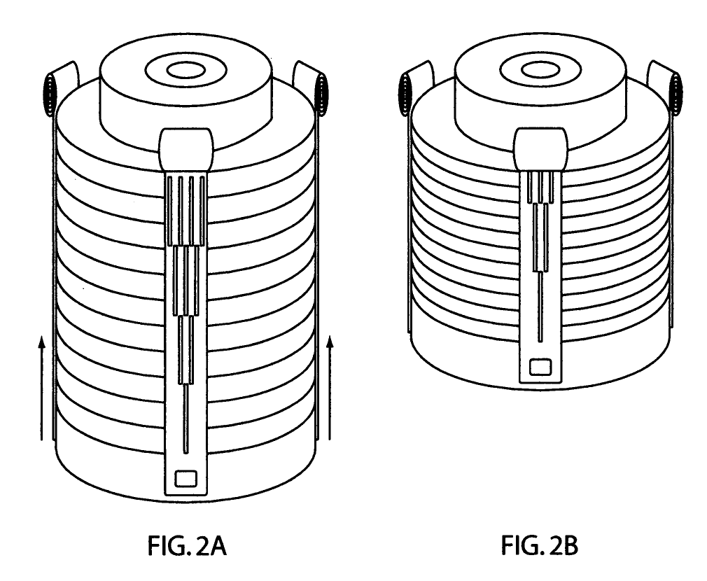

Referring to the drawings and particularly the FIGS. 1 and 2, one form of the prior art constant force spring, typically known as the “Nagator” spring is there shown in generally designated as “NS”. Negator springs “NS” are readily commercially available from a number of sources including Stock Drive Products/Sterling Instruments of new Hyde Park, N.Y. The prior art Negator extension spring comprises a pre-stressed flat strip “FS” of spring material that is formed into virtually constant radius coils around itself or on a drum “Z” having a radius R-1 (FIG. 1). The area identified in FIG. 2 of the drawings as “FGR” designates the “active region” or “the force generating region” of the constant for spring. It should be understood that in this “active region” the radius of curvature of the spring changes and it is this change in radius of curvature of the spring that is responsible for the generation of the force. In fact, the radius of curvature changes from essentially infinity to a value equal to the radius R-1 of the spool on which the spring is wound.

As will be discussed in greater detail hereinafter, increasing the mass of material in this “force generating region” will increase the force provided by the spring. Conversely, decreasing the mass of material in the “force generating region” will result in a reduction of the force generated by the spring.

The mass in the active region can be changed by changing the thickness of the spring, the width of the spring, the density of material of the spring, or any combination of these. It should be further noted that because the force generating region takes up some portion of the length of the spring it will tend to average any point-by-point changes in physical or structural properties of the spring. The variable L shown in FIG. 2 of the drawings is defined to be the distance from the force generating region to the end of the spring. When deflected, the spring material straightens as it leaves the drum (see FIG. 2). This straightened length of spring actually stores the spring's energy through its tendency to assume its natural radius.

The force delivered by a typical prior art constant force spring, such as the Negator extension spring depends on several structural and geometric factors. Structural factors include material composition and heat treatment. Geometric factors include the thickness of the spring “T”, the change in radius of curvature of the spring as the spring is extended, and the width “W” of the spring.

Turning now to a consideration of the novel variable force springs of the present invention, these springs can be constructed from various materials, such as metal, plastic, ceramic, composite and alloys, that is, intermetallic phases, intermetallic compounds, solid solution, metal-semi metal solutions including but not limited to Al/Cu, Al/Mn, Al/Si, Al/Mg, Al/Mg/Si, Al/Zn, Pb/Sn/Sb, Sn/Sb/Cu, Al/Sb, Zn/Sb, In/Sb, Sb/Pb, Au/Cu, Ti/Al/Sn, Nb/Zr, Cr/Fe, non-ferrous alloys, Cu/Mn/Ni, Al/Ni/Co, Ni/Cu/Zn, Ni/Cr, Ni/Cu/Mn, Cu/Zn, Ni/Cu/Sn. These springs comprise a novel modification of the prior art constant force springs to provide variable springs suitable for use in many diverse applications. By way of non-limiting example, one important application of the variable force springs of the present invention comprises the use of the springs in connection with fluid delivery systems of the character having collapsible fluid containing reservoirs. In this regard, an objective of many prior art fluid delivery systems of the character used to deliver additional fluids is to deliver fluid from the collapsible fluid reservoir of the device at a constant flow rate. One method for achieving a constant flow rate over time involves ensuring that the pressure driving the fluid through the device is constant, that is., ensuing that the pressure inside the fluid reservoir of the device is constant As will be better understood from the discussion that follows, by using the novel variable force spring of the present invention to controllably collapse the collapsible fluid reservoir of the fluid delivery device a constant pressure in the collapsible fluid reservoir of the device can be achieved. By way of non-limiting example, one form of container having a collapsible fluid reservoir that could be collapsed using the novel variable force springs of the present invention is illustrated in FIGS. 2A and 2B of the drawings. In the discussion that follows, the novel features of the variable for springs of the present invention will, in some cases, be described in connection with their use to controllably collapse the fluid reservoirs of collapsible containers of the character used in ambulatory fluid delivery devices to dispense a wide variety of medicinal fluids. However, it is to be understood that the variable for springs of the present invention can be used in a wide variety of other industrial applications, including counter balancing applications, carriage return applications, film wrapping applications, spring motors and various applications for transmitting motion.

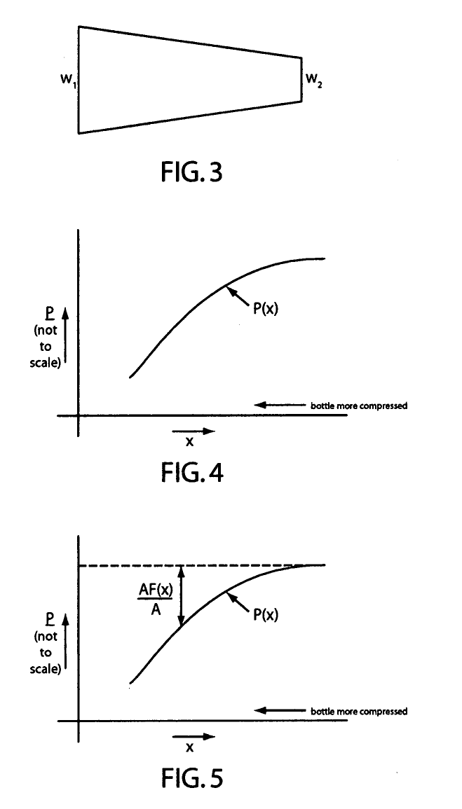

With the foregoing in mind, if one wanted to produce a spring that delivered a force that increased by a factor of two as the spring returned from its fully extended conformation to its equilibrium, or fully coiled conformation, one would require that, as illustrated in FIG. 3 of the drawings, the width of the spring change by a factor of two along its length. In the example illustrated in FIG. 3, the force will decrease by a factor of w₁/w₂ as the spring changes from a fully extended configuration to a fully retracted configuration.

With the forgoing in mind, one form of the modified spring of the present invention can be described algebraically as follows:

If x denotes the position of a point along a line that is parallel to the longitudinal axis of the spring and w(x) denotes the width of the spring at that point then:

w(x)=(constant)x

This describes the case wherein the width varies linearly with x as is shown in FIG. 3 of the drawings.

However, it is to be observed that the relationship between a position along the longitudinal axis of the spring and the width of the spring at that position need not be linear as shown in FIG. 3. Further, the width of the spring could be any arbitrary function of x. Thus:

w(x)=f(x)

where (x) denotes an arbitrary function of x.

Using this concept, springs can be designed to controllably compress the collapsible fluid reservoir of a fluid delivery device, such is that illustrated in FIG. 2A of the drawings. Stated another way, it is apparent that the concept can beneficially be employed to design a spring that generates a pressure that is independent of the degree of compression of the collapsible reservoir.

By way of example, suppose that the pressure vs. degree of compression curve for a collapsible container when compressed by a constant force spring is exemplified by the curve P(x) and the force of the constant force spring is identified as “FCFS”. Further assume that the drop in pressure as the container is compressed is due to the force “BF(x)”, which is the force required to compress the container. Then the net force producing the pressure in the container can then be written:

F(x)=FCFS−BF(x)

Assume for simplicity that the area on which the force F acts is constant and is represented by “A”. Then the pressure in the fluid container is:

P(x)=(FCFS−BF(x))/A

This equation describes, in functional form, the curve labeled P(x) in FIGS. 4 and 5, and includes explicitly the contributions of the two forces generating the pressure within the reservoir of a bellows like container such is that illustrated in FIG. 2A, that is the force due to the spring and the force due to the bellows-like container.

The foregoing analysis allows one to design a spring, the force of which changes in such a way that the sum of all forces generating the pressure in the container is independent of the degree of the compression of the container, i.e., independent of the variable x. The force delivered by such a spring can be stated as:

F(x)=FCFS+AF(x)

Where “FCFS” is the force delivered by the original constant force spring and AF(x) is an additional force whose functional form is to be determined. Thus, the modified spring can be thought of as being composed of two parts, one part delivers the force of the original constant force spring (a force independent of x) and the other delivers a force that depends on the variable x.

For this system the net force generating the pressure in the reservoir of the bellows-like container, such is that shown in FIG. 2A, is stated as:

FS(x)=F(x)−BF(x)=FCFS+AF(x)−BF(x)

Assuming that:

AF(x)=BF(x) for all x.

Then the total force compressing the container is:

FS(x)=FCFS+AF(x)−AF(x)=FCFS

which force is independent of the degree of compression of the container, and wherein the pressure within the container is independent of the degree of compression of the container.

Pₘₛ(x)=(FCFS+AF(x)−AF(x))/A=FCFS/A

Where Pₘₛ(x) denotes the pressure in the fluid reservoir when the modified spring of the invention is used.

In designing the modified spring of the present invention, the information contained in the pressure vs. displacement curve when the container is compressed by a constant force spring can be used to determine how the cross-sectional mass, in this case the width of the spring, must vary as a function of x in order that the pressure in the container when compressed with the modified spring remains constant.

The force delivered by the spring being linearly dependent on the width of the spring if all other things remain constant, thus:

AF(x)=(constant)w(x)

Substituting this into equation:

P(x)=(FCFS−BF(x))/A, then:

P(x)=(FCFS−AF(x))/A=(FCFS−constant)w(x))/A

However, it is to be observed that FCFS/A−P(x) is just the difference between the two curves shown in FIG. 5, FCFS/A being the horizontal line. Thus, the modification to the width, denoted w(x), of the original constant force spring is proportional to the difference between the two curves shown in FIG. 5. In other words, the shape of the change in the width of the spring as a function of x is similar to the difference between the two curves as a function of x. Furthermore, one can simply “read off” the shape of the curve w(x) from the pressure vs. displacement curve.

The broader utility of a variable force spring, whose width defines the specific force, may be that the spring design can be appropriately constructed to deliver a non-linear and highly variable force to meet a specific requirement. In this way, a spring that has a width that simply decreases as it is unrolled could be used. Alternatively, the spring could have an increasing width, followed by a width that decreases again during its distention. The spring force provided is therefore highly tunable to meet a variety of applications and requirements, simply by constructing a spring of specific width at the desired distension. Although a virtually infinite number of designs are possible, by way of non-limiting example, several differently configured springs are illustrated in FIGS. 3 through 23 of the drawings.

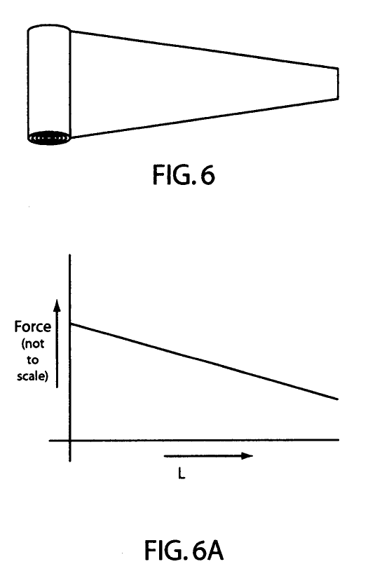

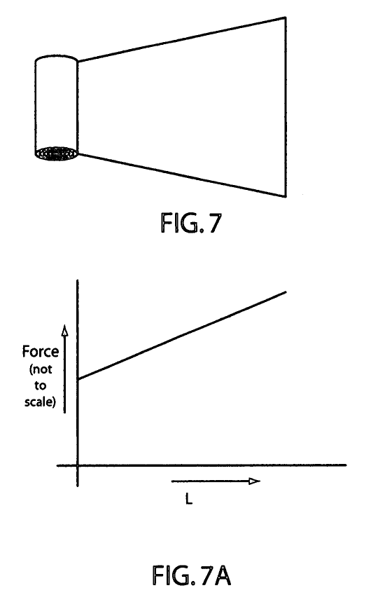

Referring to FIG. 6 of the drawings one form of variable force spring having varying cross-sectional mass along its length is there illustrated. In this instance, the varying cross-sectional mass is achieved by a constant force spring that has been modified to exhibit varying width along its length. As shown in FIG. 6A, which is a plot of Force versus “L”, where “L” is the distance from the force generating region of the spring to the end of the spring., the spring provides a decreasing force as it is retracted. Conversely, the spring depicted in FIG. 7 of the drawings, which also achieves varying cross-sectional mass by a spring exhibiting varying width along its length, provides a greater force as it retracts (see FIG. 7A).

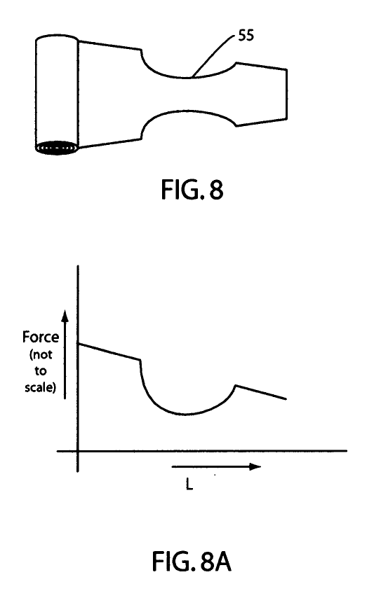

With regard to the spring depicted in FIG. 8, this spring achieves varying cross-sectional mass by a constant force spring that has been modified to exhibit varying width along its length and also to exhibit at least one area of reduced width along its length. As illustrated in FIG. 8A of the drawings, as this spring rolls up from the extended position shown in FIG. 8, it will provide gradually less force, followed by a non-linear reduction in force at the area designated in FIG. 8 as 55, followed again by a non-linear increase in force, and finally at the point at which it is almost completely retracted, exhibits a gradually decreasing force.

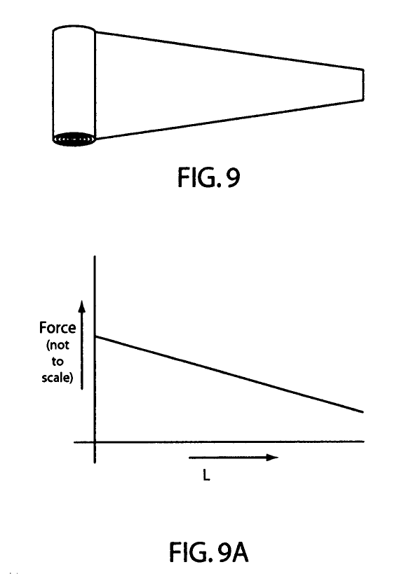

FIG. 9 is a generally illustrative view of the retractable spring of a modified configuration somewhat similar to that shown in FIG. 6 of the drawings. In this latest spring configuration the varying cross-sectional mass is once again achieved by a constant force spring that has been modified to exhibit varying width along its length. As illustrated in FIG. 9A, which is a generally graphical representation plotting force exerted by the spring shown in FIG. 9 versus “L”, the spring provides a decreasing force as it is retracted.

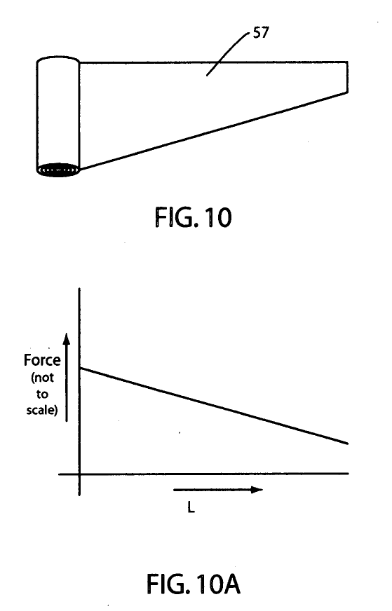

FIG. 10 is a generally illustrative view of still another form of retractable spring wherein the varying cross-sectional mass is achieved by a constant force spring that has been modified to exhibit varying width along its length. More particularly, this latest form of the modified spring exhibits a tapered body portion 57. As illustrated in FIG. 10A, which is a generally graphical representation plotting force exerted by the spring shown in FIG. 10 versus “L”, that is the distance from the force generating region of the spring to the end of the spring, the spring provides a decreasing force as it is retracted.

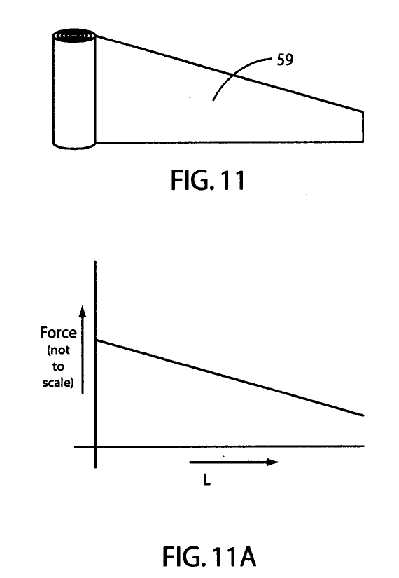

FIG. 11 is a generally illustrative view of the yet another form of retractable spring wherein the varying cross-sectional mass is achieved by a constant force spring that has been modified to exhibit varying width along its length. More particularly, this latest form of the modified spring exhibits a tapered body portion 59, which unlike the body portion 57 of the spring shown in FIG. 10 tapers downwardly rather than upwardly. As illustrated in FIG. 11A, which is a generally graphical representation plotting force exerted by the spring shown in FIG. 11 versus “L”, the spring provides a decreasing force as it is retracted.

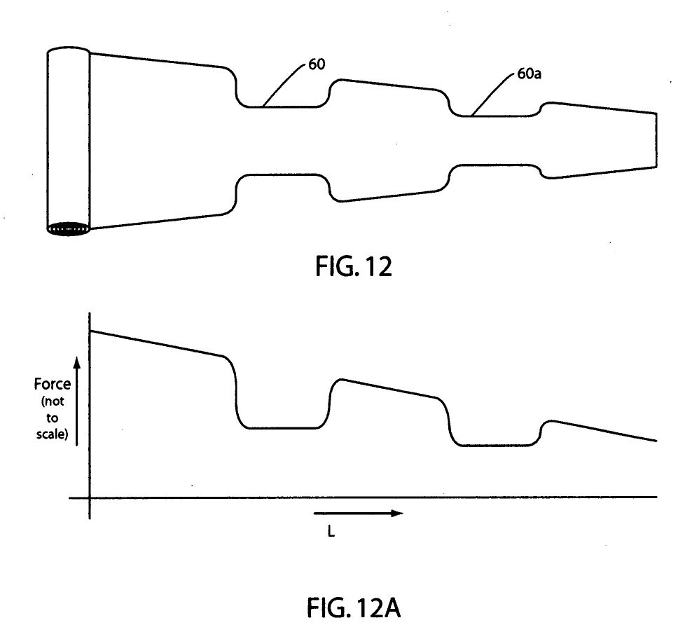

With regard to the spring depicted in FIG. 12, this spring, which is somewhat similar to the spring configuration shown in FIG. 8 of the drawings, achieves varying cross-sectional mass by a constant force spring that has been modified to exhibit varying width along its length and also to exhibit a plurality of areas of reduced width along its length. As illustrated in FIG. 12A of the drawings, as this spring rolls up from the extended position shown in FIG. 12, it will provide gradually less force, followed by a non-linear reduction in force at the area designated in FIG. 12 as 60, followed again by a non-linear increase in force, followed by a non-linear reduction in force at the area designated in FIG. 12 as 60a and finally at the point at which it is almost completely retracted, once again exhibits a gradually decreasing force.

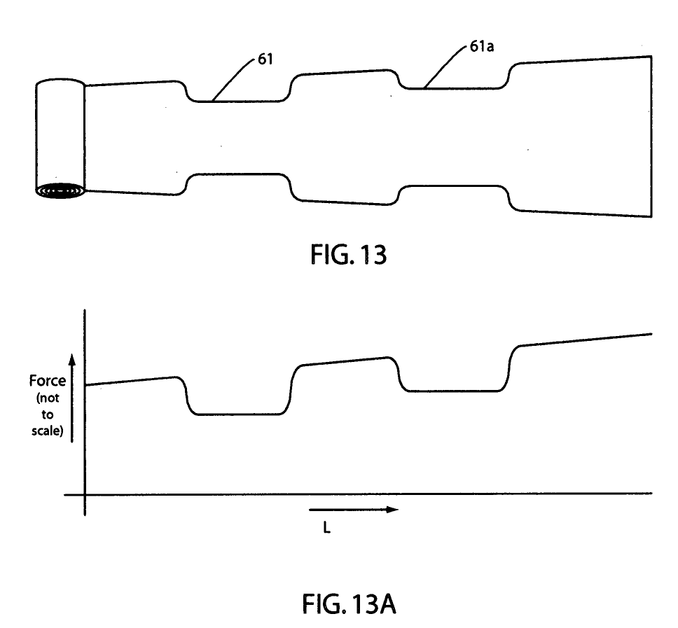

Referring next to FIG. 13 of the drawings, the spring there depicted, which is somewhat similar to the spring configuration shown in FIG. 12 of the drawings, achieves varying cross-sectional mass by a constant force spring that has also been modified to exhibit varying width along its length and also to exhibit a plurality of areas of reduced width along its length. However, as illustrated in FIG.13A of the drawings, as this spring rolls up from the extended position shown in FIG. 13, it will provide gradually increased force, followed by a non-linear decrease in force at the area designated in FIG. 13 as 61, followed again by a non-linear increase in force, followed by a non-linear decrease in force at the area designated in FIG. 13 as 61 a and finally at the point at which it is almost completely retracted, once again exhibits a gradually increasing force.

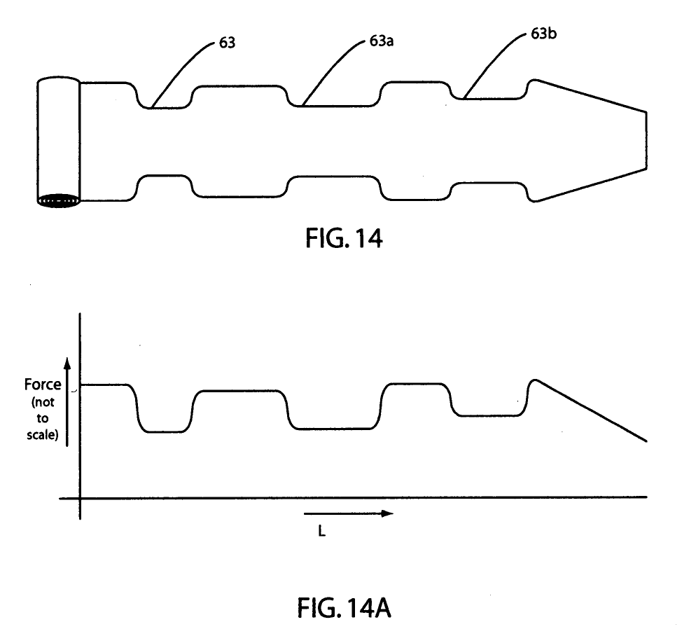

Turning next to FIG. 14 of the drawings, the spring there depicted is also somewhat similar to the spring configuration shown in FIG. 12 of the drawings. However, the spring shown in FIG. 14 does not exhibit a tapered central body portion like that of the spring illustrated in FIG. 12. Rather, the spring achieves varying cross-sectional mass by a constant force spring that has also been modified only to exhibit a plurality of areas of reduced width along its length. As illustrated in FIG. 14A of the drawings, as this spring rolls up from the extended position shown in FIG. 14, it will provide a slightly decreased force, followed by a non-linear decrease in force at the area designated in FIG. 14 as 63, followed again by a non-linear increase in force, followed by a non-linear decrease in force at the area designated in FIG. 14 as 63a, followed again by a non-linear increase in force, followed by a non-linear decrease in force at the area designated in FIG. 14 as 63b and finally at the point at which it is almost completely retracted, once again exhibits a gradually decreasing force.

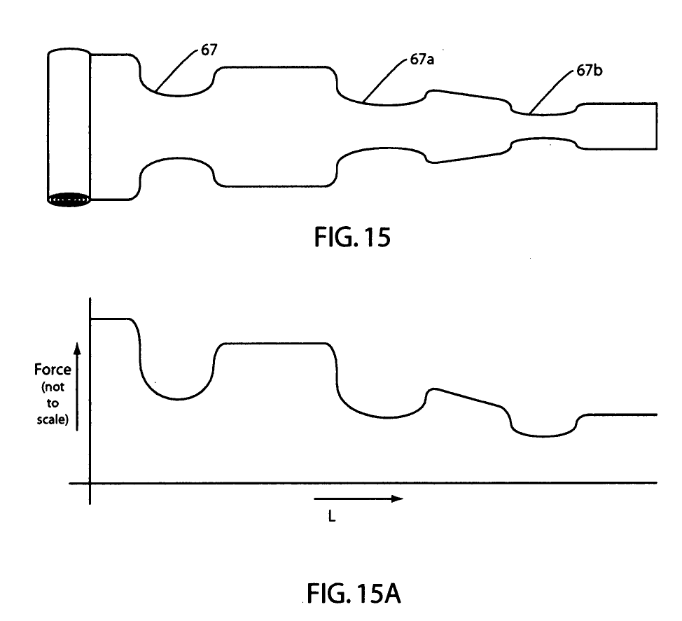

Referring now to FIG. 15 of the drawings, the spring there depicted is also somewhat similar to the spring configuration shown in FIG. 12 of the drawings. However, the spring shown in FIG. 15 exhibits both a non-tapered body portion such as that of the spring shown in FIG. 14 and also exhibits a tapered body portion like that of the spring illustrated in FIG. 12. In this instance, the spring achieves varying cross-sectional mass by a constant force spring that has been modified to exhibit a reduced width along its length and has also been modified to exhibit a plurality of areas of reduced width along its length. As illustrated in FIG. 1SA of the drawings, as this spring rolls up from the extended position shown in FIG. 15, it will provide a generally linear force, followed by a non-linear decrease in force at the area designated in FIG. 15 as 67, followed again by a non-linear increase in force, followed by a generally linear force, followed by a non-linear decrease in force at the area designated in FIG. 15 as 67a, followed again by a non-linear increase in force, followed by a non-linear decrease in force at the area designated in FIG. 15 as 67b and finally at the point at which it is almost completely retracted, once again exhibits a generally linear force.

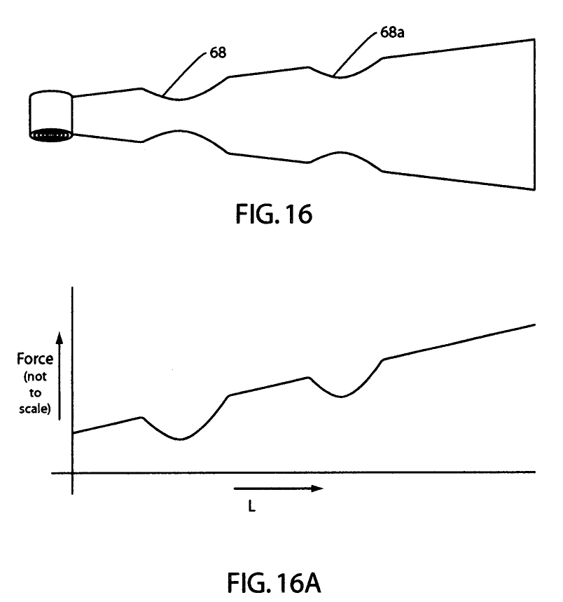

Referring next to FIG. 16 of the drawings, the spring there depicted achieves varying cross-sectional mass by a constant force spring that has been modified to exhibit an increased width along its length and has also been modified to exhibit a plurality of areas of reduced width along its length. As illustrated in FIG. 16A of the drawings, as this spring rolls up from the extended position shown in FIG. 16, it will provide an increase in force, followed by a non-linear decrease in force at the area designated in FIG. 16 as 68, followed again by a non-linear increase in force, followed by a gradually increasing force, followed by a non-linear decrease in force at the area designated in FIG. 16 as 68a, followed by an increase in force and finally at the point at which it is almost completely retracted, once again exhibits a substantial increase in force.

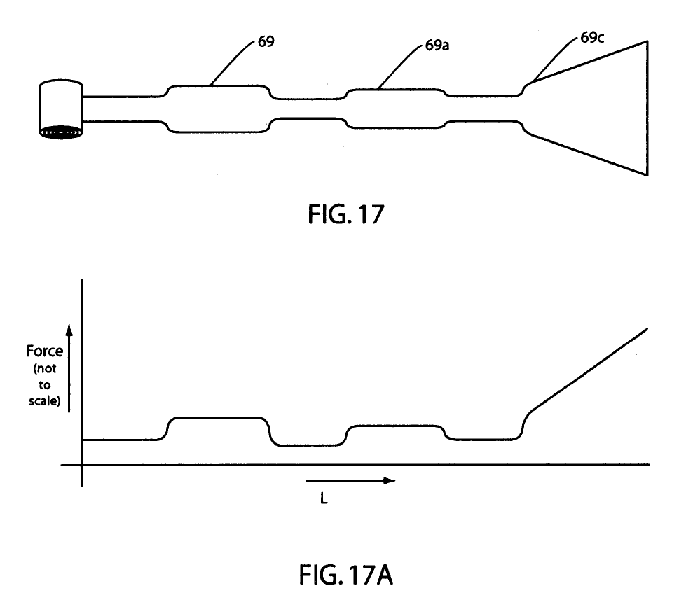

Turning next to FIG. 17 of the drawings, the spring there depicted is somewhat similar to the spring configuration shown in FIG. 14 of the drawings and does not exhibit a tapered, central body portion like that of the spring illustrated in FIG. 12. Rather, the spring achieves varying cross-sectional mass by a constant force spring that has been modified in its central body portion to exhibit a plurality of areas of reduced width along its length and uniquely exhibits an outwardly tapered end portion. As illustrated in FIG. 17A of the drawings, as this spring rolls up from the extended position shown in FIG. 17, it will provide an increase in force at the area designated in FIG. 17 as 69, followed by a decrease in force, followed by an increase in force at the area designated in FIG. 17 as 69a, followed again by a decrease in force and finally at the point 69c at which it is almost completely retracted, will exhibit a gradually increasing force.

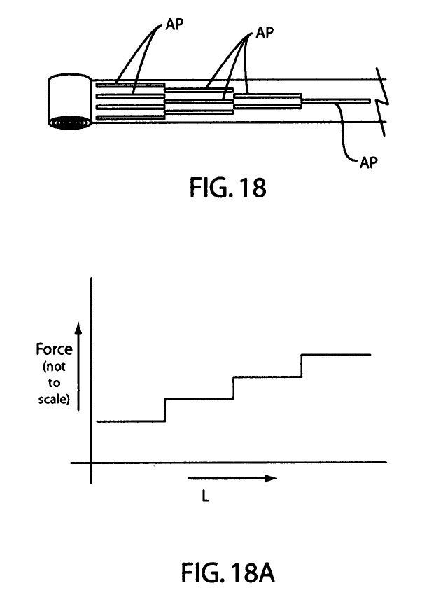

Referring to FIG. 18 of the drawings still another form of variable force spring having varying cross-sectional mass along its length is there illustrated. In this instance, the varying cross-sectional mass is achieved by a constant force spring wherein the force generating region of the spring has been modified to include a plurality of spaced-apart apertures, or slits “AP” along its length. As shown in FIG. 18A, which is a schematic plot (not to scale) of force versus cross-sectional mass, the spring uniquely provides an increasing force in a stair step fashion as it is retracted. It is to be understood, that the apertures formed in the pre-stressed strip of spring material can be located in any desired configuration and can be both transversely and longitudinally spaced-apart to provide the desired force as the spring is retracted.

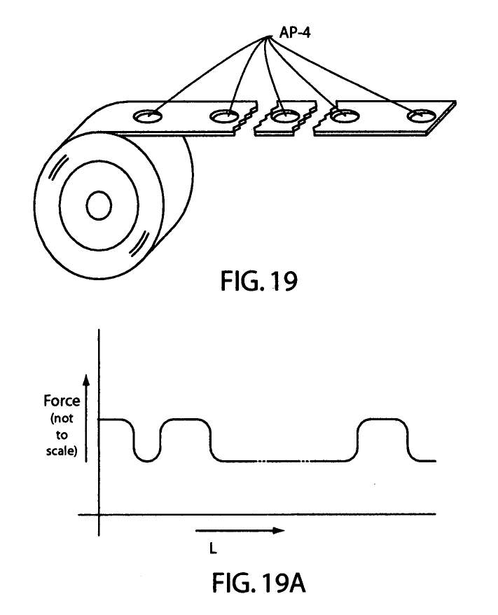

Turning next to FIG. 19, still in other form of variable force spring having varying cross-sectional mass along its length is there illustrated. In this instance, the varying cross-sectional mass is once again achieved by a constant force spring wherein the force generating region of the spring has been modified to include a plurality of spaced-apart, generally circular-shaped apertures “AP-4” along its length. As shown in FIG. 19A, which is a plot of force versus cross-sectional mass, the spring uniquely provides a decrease in force, followed by an increase in force, followed again by a lengthy decrease in force, followed by an increase in force and then followed by another decrease in force as it is retracted.

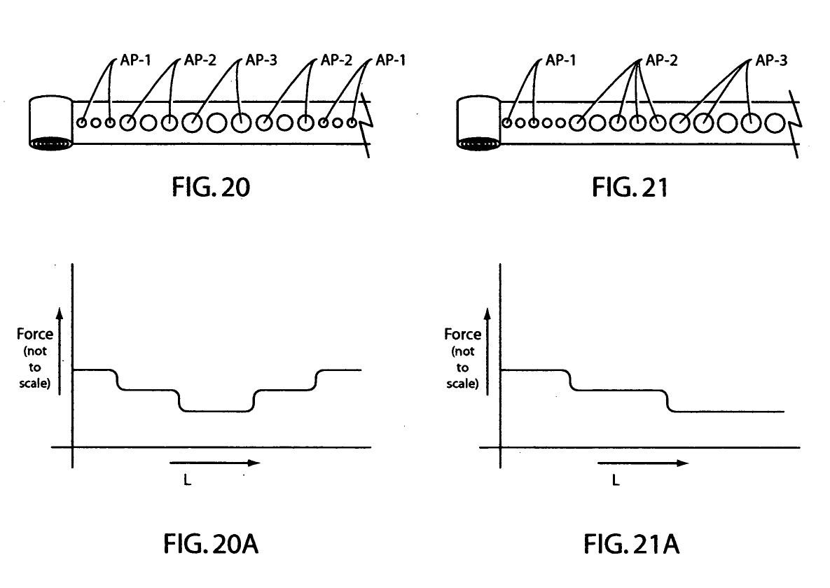

Referring to FIG. 20, still in other form of variable force spring having varying cross-sectional mass along its length is there illustrated. In this instance, the varying cross-sectional mass is once again achieved by a constant force spring wherein the force generating region of the spring has been modified to include a plurality of spaced-apart, generally circular-shaped apertures “AP-1”, “AP-2” and “AP-3” of different sizes along its length. As shown in FIG. 20A, which is a plot of force versus cross-sectional mass, the spring uniquely provides the desired variable decrease in force followed by the desired variable increase in force as it is retracted.

Turning to FIG. 21, still in other form of variable force spring having varying cross-sectional mass along its length is there illustrated. In this instance, the varying cross-sectional mass is once again achieved by a constant force spring wherein the force generating region of the spring has been modified to include a plurality of spaced-apart, generally circular-shaped apertures of different sizes along its length. As shown in FIG. 21 A, which is a plot of force versus cross-sectional mass, the spring uniquely provides the desired variable decrease in force as it is retracted.

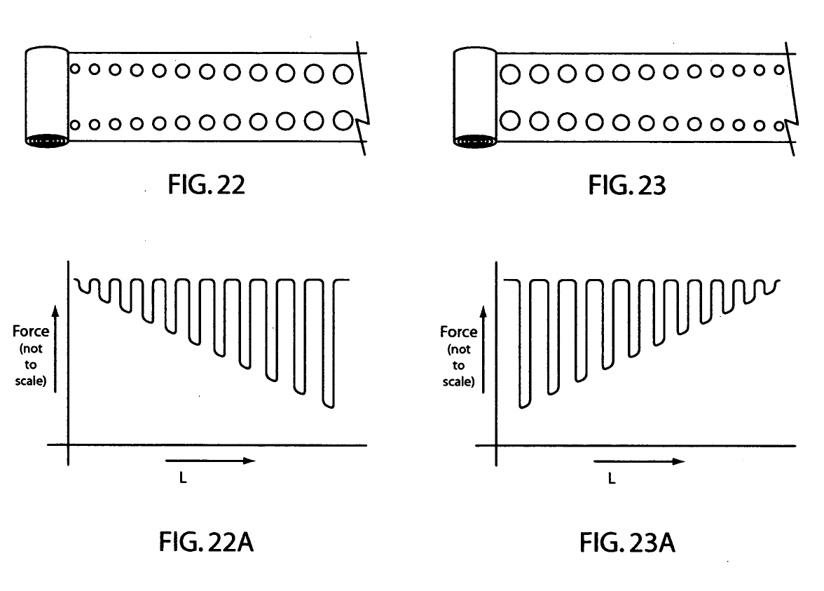

Referring to FIG. 22, still in other form of variable force spring having varying cross-sectional mass along its length is there illustrated. In this instance, the varying cross-sectional mass is once again achieved by a constant force spring wherein the force generating region of the spring has been modified to include a plurality of transversely and longitudinally spaced-apart, generally circular-shaped apertures of increasing diameter in a direction away from the force generating region. As shown in FIG. 22 A, which is a plot of force versus cross-sectional mass, the spring uniquely provides the desired variable decrease in force as it is retracted.

Referring to FIG. 23, still in other form of variable force spring having varying cross-sectional mass along its length is there illustrated. In this instance, the varying cross-sectional mass is once again achieved by a constant force spring wherein the force generating region of the spring has been modified to include a plurality of transversely and longitudinally spaced-apart, generally circular-shaped apertures of decreasing diameter in a direction away from the force generating region. As shown in FIG. 23 A, which is a plot of force versus cross-sectional mass, the spring uniquely provides the desired variable increase in force as it is retracted.

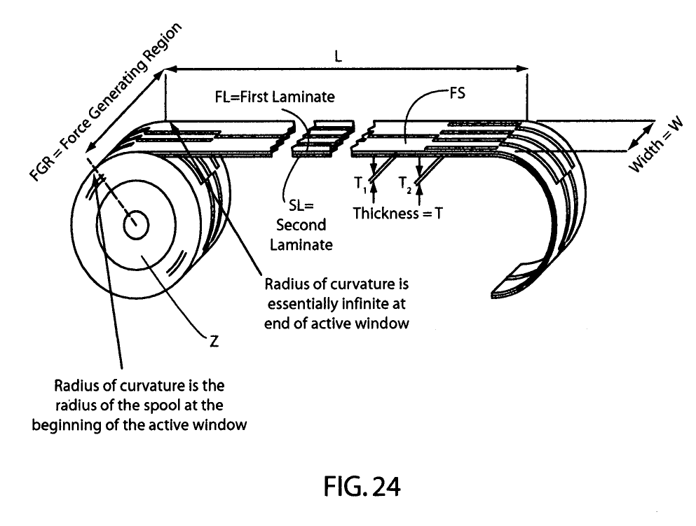

Referring to FIG. 24, still in other form of variable force spring having varying cross-sectional mass along its length is there illustrated. In this instance, the varying cross-sectional mass is once again achieved by a constant force spring of a laminate construction having a first laminate “FL” and a second interconnected laminate “SL”. Once again, the force generating region of the spring has been modified to include a plurality of transversely and longitudinally spaced-apart, generally slit like apertures of different sizes. As before, the spring uniquely provides the desired variable increase in force as it is retracted.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A variable force spring comprising an elongated, pre-stressed strip of spring material having a length and a cross-sectional mass that varies along said length.

2. The variable force spring as defined in claim 1 in which said elongated, pre-stressed strip of spring material varies in width along its length.

3. The variable force spring as defined in claim 1 in which said elongated, pre-stressed strip of spring material varies in width along its length and includes at least one area of reduced width along its length.

4. The variable force spring as defined in claim 1 in which said elongated, pre-stressed strip of spring material varies in width along its length and includes a plurality of spaced-apart areas of reduced width along its length.

5. The variable force spring as defined in claim 1 in which said elongated, pre-stressed strip of spring material is tapered along its length.

6. The variable force spring as defined in claim 1 in which said elongated, pre-stressed strip of spring material is tapered along its length and includes at least one area of reduced width along its length.

7. The variable force spring as defined in claim 1 in which said elongated, pre-stressed strip of spring material is tapered along its length and includes a plurality of spaced-apart areas of reduced width along its length.

8. The variable force spring as defined in claim 1 in which said elongated, pre-stressed strip of spring material includes a plurality of spaced-apart apertures along its length.

9. The variable force spring as defined in claim 1 in which said elongated, pre-stressed strip of spring material includes a plurality of spaced-apart slits along its length.

10. The variable force spring as defined in claim 1 in which said elongated, pre-stressed strip of spring material is constructed from steel.

11. The variable force spring as defined in claim 1 in which said elongated, pre-stressed strip of spring material is constructed from plastic.

12. A variable force spring comprising an elongated, pre-stressed strip of spring material that is formed into coils of substantially constant radius, said strip having a first end and a second end.

13. The variable force spring as defined in claim 12 in which said elongated, pre-stressed strip of spring material is tapered between said first and second ends.

14. The variable force spring as defined in claim 12 in which said elongated, pre-stressed strip of spring material is tapered between said first and second ends and includes at least one area of reduced width between said first and second ends.

15. The variable force spring as defined in claim 12 in which said elongated, pre-stressed strip of spring material is tapered between said first and second ends and includes in a plurality of spaced-apart areas of reduced width between said first and second ends.

16. The variable force spring as defined in claim 12 in which said elongated, pre-stressed strip of spring material a plurality of spaced-apart apertures between said first and second ends.

17. The variable force spring as defined in claim 12 in which said elongated, pre-stressed strip of spring material is of a laminate construction having a plurality of spaced-apart apertures between said first and second ends.

18. The variable force spring as defined in claim 12 in which said elongated, pre-stressed strip of spring material is constructed from metal and metal alloys selected from the group consisting of Al/Cu, Al/Mn, Al/Si, Al/Mg, Al/Mg/Si, Al/Zn, Pb/Sn/Sb, Sn/Sb/Cu, Al/Sb, Zn/Sb, In/Sb, Sb/Pb, Au/Cu, Ti/Al/Sn, Nb/Zr, Cr/Fe, Cu/Mn/Ni, Al/Ni/Co, Ni/Cu/Zn, Ni/Cr, Ni/Cu/Mn, Cu/Zn and Ni/Cu/Sn.

19. The variable force spring as defined in claim 12 is constructed from ceramic materials.
